(19) United States
(12) Patent Application Publication
(10) Pub. No.: US 2009/0145041 A1
(43) Pub. Date: Jun. 11, 2009

(54) DOOR FOR THE VEHICLE

(75) Inventors: Kazuki YAMADA, Toyota-shi (JP); Masami URATSU, Aichi-ken (JP); Makoto HORIBA, Toyota-shi (JP); Junichi KAWAKAMI, Aichi-ken (JP)

Correspondence Address: GREENBLUM & BERNSTEIN, P.L.C., 1950 ROLAND CLARKE PLACE, RESTON, VA, 20191, US

(73) Assignee: TOYOTA BOSHOKU KABUSHIKI KAISHA, Aichi-ken (JP)

(21) Appl. No.: 12/326,982

(22) Filed: Dec. 3, 2008

(30) Foreign Application Priority Data
Dec. 5, 2007 (JP) 2007-314710

(51) Int. Cl. B60J 5/04

(52) U.S. Cl. 49/501

(57) ABSTRACT

A door for the vehicle which comprises: a door inner panel, a door trim mounted to the inner side of a compartment of the door inner panel, a door cover mounted on the peripheral edge in the rear side of a compartment of the door inner panel. The door trim and the door cover are mutually coupled by a coupling means. The coupling means is composed of a positioning pin, a positioning bracket, and a clip.

### CROSS REFERENCE TO RELATED APPLICATION

This application claims priority from Japanese Patent Application No. 2007-314710 filed Dec. 5, 2007. The entire content of this priority application is incorporated herein by reference.

### TECHNICAL FIELD

The present invention relates to a door for the vehicle comprising a door trim and a door cover.

### BACKGROUND

Conventionally, a door for the vehicle has been well-known which has a door trim mounted to the inner side of a compartment of a door inner panel and a door cover mounted on the peripheral edge in the rear side of a compartment of the door inner panel (see Patent Document 1).

Patent Document 1: Japanese Unexamined Patent Publication No. 2005-205964

FIG. 5 is an elevation view showing a conventional door for the vehicle 100. FIG. 6 is a cross-sectional view taken along a line B-B in a door for the vehicle 100 in FIG. 5. As shown in FIG. 5, the conventional door for the vehicle 100 comprises a door inner panel 102. A door trim 104 is mounted to the inner side of a compartment of the door inner panel 102. On the peripheral edge in the rear side of a compartment of the door inner panel 102, a door cover 106 is mounted. The door trim 104 and the door cover 106 are respectively attached to the door inner panel 102 by such as a clip not shown.

In the conventional door for the vehicle 100, the door trim 104 and the door cover 106 are attached respectively to the door inner panel 102. However, the door trim 104 and the door cover 106 are not coupled mutually.

As shown in FIG. 6, the door trim 104 and the door cover 106 are therefore separated at the section where the door trim 104 and the door cover 106 are overlapping each other, and this causes the generation of a clearance 108 between the door trim 104 and the door cover 106. As a result, there has been a problem in that the appearance of the door for the vehicle 100 deteriorates.

The present invention has been made on the basis of the above situation, with an object of providing a door for the vehicle having a good appearance and no clearance between a door trim and a door cover.

### SUMMARY

The first aspect of the present invention relates to a door for the vehicle which comprises: a door inner panel, a door trim mounted to the inner side of a compartment of the door inner panel, a door cover mounted on the peripheral edge in the rear side of a compartment of the door inner panel, and a coupling means for coupling the door trim and the door cover mutually.

According to the first aspect of the invention, the door trim and the door cover are coupled mutually. Therefore, in the section where the door trim and the door cover are overlapping each other, the generation of a clearance between the door trim and the door cover can be prevented. This improves the appearance of the door for the vehicle.

The second aspect of the invention relates to the door for the vehicle according to the first aspect of the invention, wherein a positioning pin is provided in the door trim, a positioning bracket is provided in the door cover, and an insertion hole into which the positioning pin is inserted is formed in the bracket.

According to the second aspect of the invention, the door trim can be positioned relative to the door cover. This further improves the appearance of the section where the door trim and the door cover are overlapping each other.

The third aspect of the invention relates to the door for the vehicle according to the second aspect of the invention, comprising a clip for preventing the positioning pin from slipping off the insertion hole in such a state that the positioning pin is inserted in the insertion hole, wherein the clip is constituted separately from the positioning pin and the positioning bracket, and the coupling means is composed of the positioning pin, the positioning bracket and the clip.

According to the third aspect of the invention, a positioning means (the positioning pin and the positioning bracket) for positioning the door trim relative to the door cover can be utilized as a coupling means for mutually coupling the door trim and the door cover. Consequently, there is no need to individually provide the positioning means and the coupling means, and thus, the production of the door for the vehicle at low cost can be achieved.

The fourth aspect of the invention relates to the door for the vehicle according to the first to third aspects of the invention, wherein the door trim is vertically divided, and the dividing position in the vertical direction of the door trim coincides with the upper end position of the door cover.

According to the fourth aspect of the invention, the dividing position in the vertical direction of the door trim coincides with the upper end position of the door cover. This further improves the appearance of the section where the door trim and the door cover are overlapping each other.

The present invention enables to provide the door for the vehicle having a good appearance and no clearance between the door trim and the door cover.

### BRIEF DESCRIPTION OF THE DRAWINGS

FIG. 1 is an elevation view showing a door for the vehicle;

FIG. 2 is a cross-sectional view taken along a line A-A in a door for the vehicle in FIG. 1;

FIG. 3 is a perspective view of a coupling means;

FIG. 4 is a cross-sectional view of a positioning bracket and a clip, indicating a state where a positioning pin with a clip attached thereto was inserted into an insertion hole;

FIG. 5 is an elevation view showing a conventional door for the vehicle;

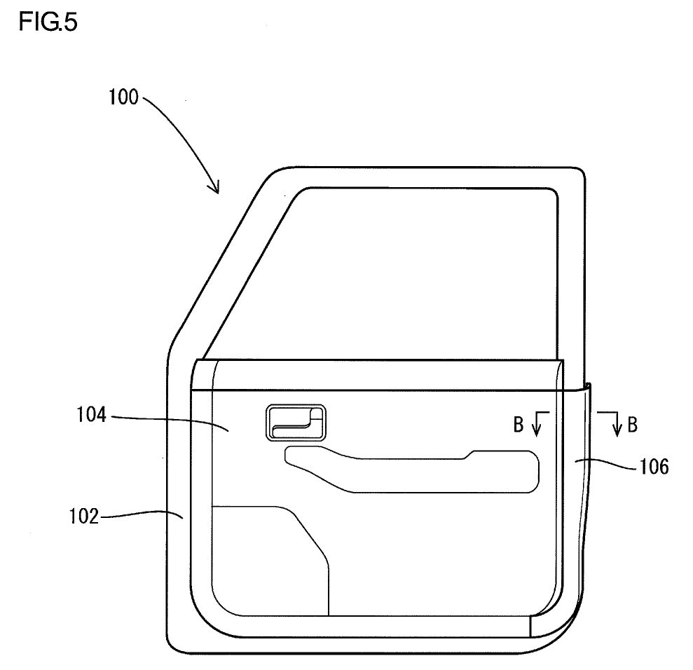

FIG. 6 is a cross-sectional view taken along a line B-B in a door for the vehicle in FIG. 5.

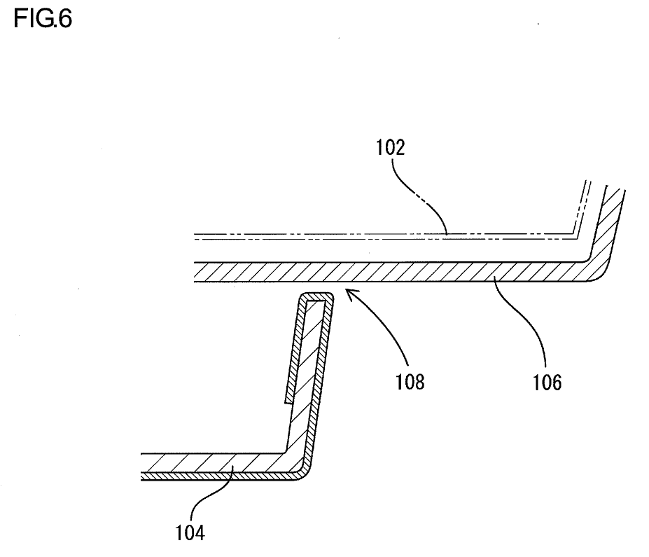

### DETAILED DESCRIPTION OF THE PREFERRED ILLUSTRATIVE ASPECTS

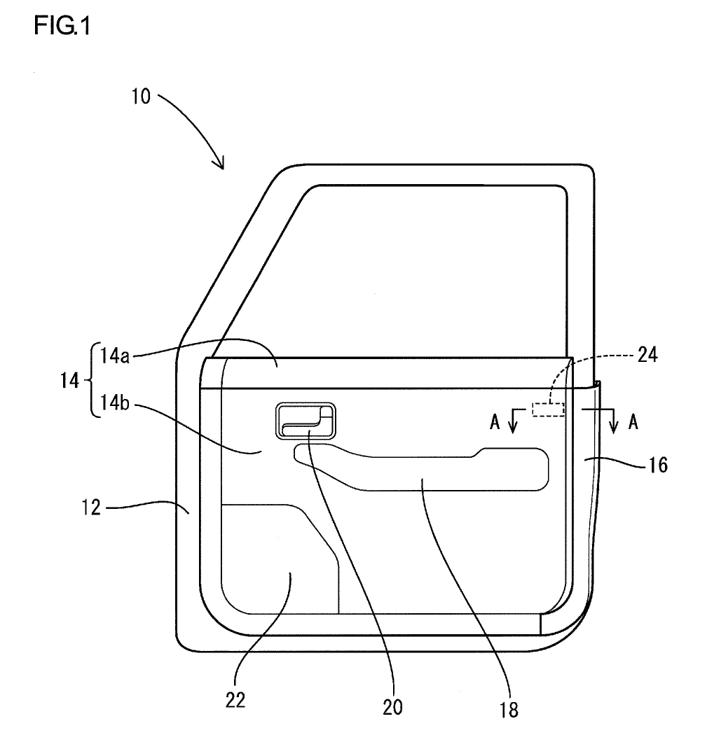

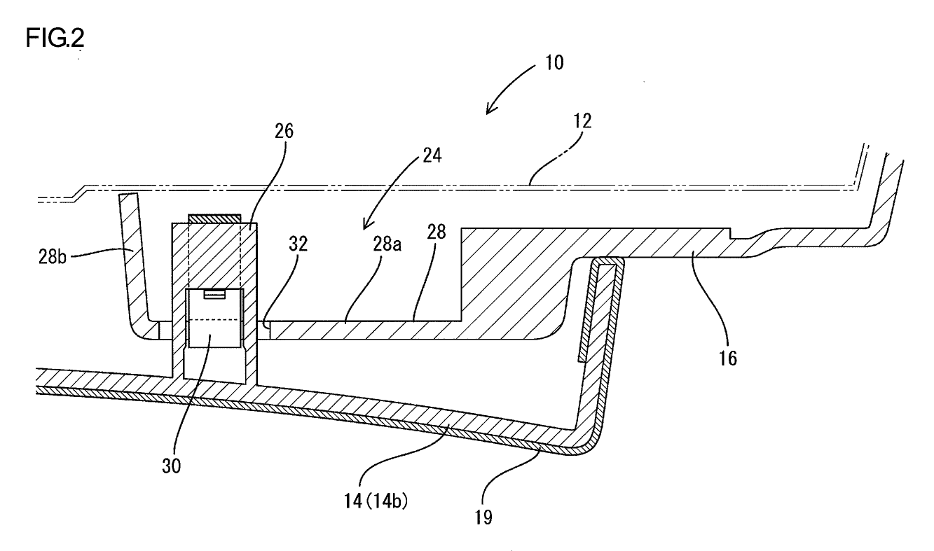

In what follows, embodiments of the present invention are described as referring to the drawings. FIG. 1 is an elevation view showing a door for the vehicle 10 according to the present embodiment. FIG. 2 is a cross-sectional view taken along a line A-A in a door for the vehicle 10 in FIG. 1. In FIGS. 1 and 2, the left side is the front side of the vehicle, while the right side is the rear side of the vehicle.

The door for the vehicle 10 according to the present embodiment is for the use as a door in the driver's seat side or in the passenger's seat side in the front seats of a vehicle. As shown in FIG. 1, the door for the vehicle 10 includes a door inner panel 12, a door trim 14, and a door cover 16.

The door inner panel 12 is made of a metallic plate member. The door inner panel 12 composes an exterior member of the body of the door for the vehicle 10. The door inner panel 12 and a door outer panel (not shown in FIGS. 1 and 2) are joined together to compose an exterior member of the body of the door for the vehicle 10.

The door trim 14 is an interior member comprising the base material made of such as a synthetic resin. The door trim 14 comprises various equipments such as an arm rest 18, an inner side door handle 20, and a speaker 22, and is mounted to the inner side of a compartment of the door inner panel 12 by such as a clip. The entire or partial surface in the inner side of a compartment of the door trim 14 is covered with a skin material 19 (see FIG. 2). The skin material 19 is made of such as a woven cloth, a non-woven cloth, a resin sheet, or a leather.

The door trim 14 is composed of an upper board 14a and a lower board 14b. The upper board 14a is a member constituting an upper edge part of the door trim 14. The lower board 14b is a member composing the part other than the upper edge part of the door trim 14. In short, the door trim 14 is vertically divided into at least two members (the upper board 14a and the lower board 14b). The boundary position between the upper board 14a and the lower board 14b coincides with the upper end position of the door cover 16.

The door cover 16 is an interior member made of such as a synthetic resin, and mounted on the peripheral edge in the rear side of a compartment of the door inner panel 12 by such as a clip. The door cover 16 is covering the joint part between the door inner panel 12 and the door outer panel (not shown in FIGS. 1 and 2). Therefore, the part which cannot be covered with the door trim 14 is covered with the door cover 16, and thereby improving the appearance of the door for the vehicle 10.

As shown in FIGS. 1 and 2, the peripheral edge in the rear side of a compartment of the door trim 14 is overlapping the surface in the inner side of a compartment of the door cover 16. A coupling means 24 for mutually coupling the door trim 14 and the door cover 16 is provided in the overlapping part of the door trim 14 and the door cover 16.

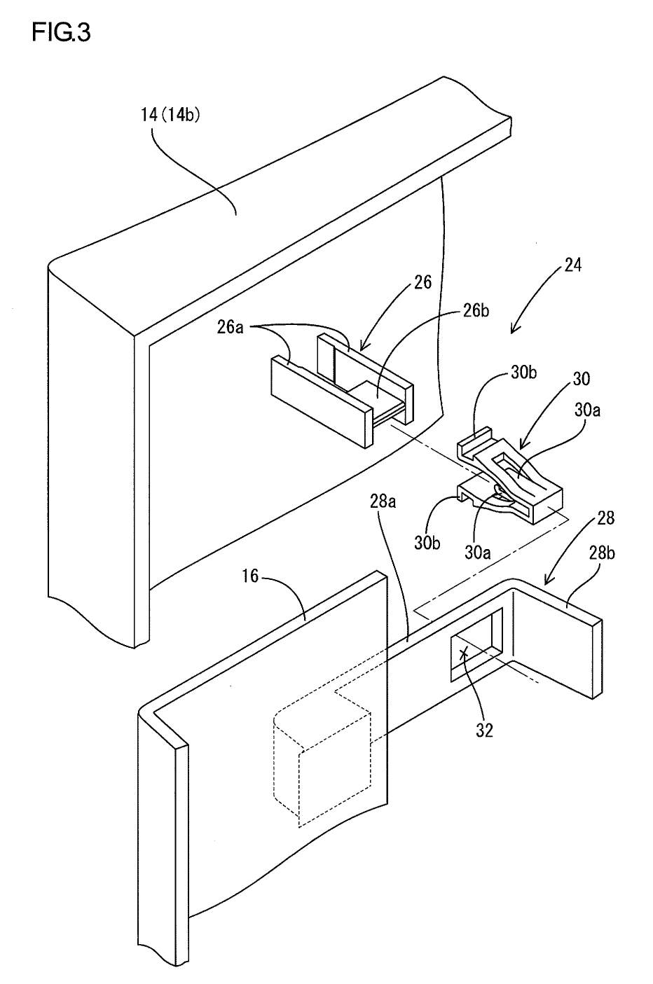

FIG. 3 is a perspective view of the coupling means 24. In FIG. 3, the upper left side is the inner side of a compartment, while the lower right side is the outer side of a compartment.

As shown in FIG. 3, the coupling means 24 for mutually coupling the door trim 14 and the door cover 16 is provided in the part where the door trim 14 overlaps the door cover 16. The coupling means 24 is composed of a positioning pin 26, a positioning bracket 28, and a clip 30.

The positioning pin 26 is integrally provided on the surface in the outer side of a compartment of the door trim 14. The positioning pin 26 comprises a pair of legs 26a protruding toward the outer side of a compartment from the surface in the outer side of a compartment of the door trim 14 and a bridge part 26b bridging between the pair of legs 26a.

The positioning bracket 28 is integrally provided on the surface in the inner side of a compartment of the door cover 16. The positioning bracket 28 comprises an extension part 28a extending toward the front side of a compartment from the surface in the inner side of a compartment of the door cover 16 and a bend part 28b nearly-perpendicularly bending toward the outer side of a compartment from the end of the extension part 28a. An insertion hole 32 into which the positioning pin 26 can be inserted from the inner side of a compartment is formed in the extension part 28a.

The clip 30 is made of a resin such as polypropylene, and formed separately from the positioning pin 26 and the positioning bracket 28. The clip 30 comprises a first engaging pawl 30a and a second engaging pawl 30b.

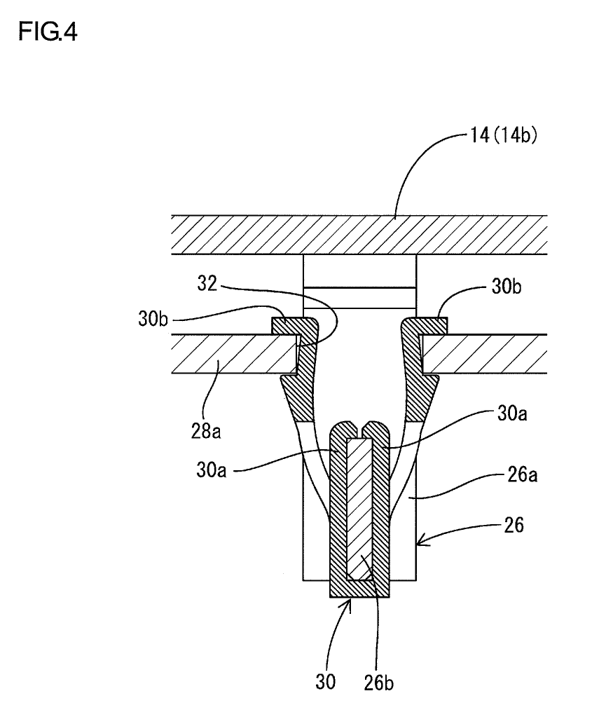

FIG. 4 is a cross-sectional view of the positioning bracket 28 and the clip 30, indicating a state where the positioning pin 26 with the clip 30 attached thereto was inserted into the insertion hole 32.

As shown in FIG. 4, pushing the clip 30 toward the positioning pin 26 enables the first engaging pawl 30a provided in the clip 30 to engage with the bridge part 26b provided in the positioning pin 26. This allows the clip 30 to be attached to the positioning pin 26.

In addition, as shown in FIG. 4, inserting the positioning pin 26 with the clip 30 attached thereto into the insertion hole 32 enables the second engaging pawl 30b provided in the clip 30 to engage with the inner edge of the insertion hole 32. This enables prevention of the positioning pin 26 from slipping off the insertion hole 32, and at the same time, allowing the door trim 14 and the door cover 16 to couple together in a mutually overlapped state.

In what follows, the working effect of the door for the vehicle 10 according to the present embodiment is described.

The coupling means 24 allows the door trim 14 and the door cover 16 to couple mutually. This allows the prevention of a clearance between the door trim 14 and the door cover 16 from generating in the section where the door trim 14 and the door cover 16 are overlapping each other. As a result, the appearance of the door for the vehicle 10 can be improved.

The positioning pin 26 and the positioning bracket 28 enable the door trim 14 to be positioned relative to the door cover 16, and therefore, the appearance of the overlapping section of the door trim 14 and the door cover 16 can be further improved.

A positioning means (the positioning pin 26 and the positioning bracket 28) for positioning the door trim 14 relative to the door cover 16 can be utilized as the coupling means 24 for mutually coupling the door trim 14 and the door cover 16. As a result, there is no need to individually provide the positioning means and the coupling means 24, and thus, the production of the door for the vehicle 10 at low cost can be achieved.

The dividing position (the boundary position between the upper board 14a and the lower board 14b ) in the vertical direction of the door trim 14 coincides with the upper end position of the door cover 16. As a result, a dividing line of the door trim 14 looks as if connected to the upper end of the door cover 16 in a straight line (see FIG. 1), and therefore, the appearance of the section where the door trim 14 and the door cover 16 are overlapping each other can be further improved.

The door trim 14 and the door cover 16 are mutually coupled by the coupling means 24, so that a noncoincidence between the dividing position in the vertical direction of the door trim 14 and the upper end position of the door cover 16 can be prevented.

### OTHER EMBODIMENTS

With embodiments of the present invention described above with reference to the accompanying drawings, it is to be understood that the invention is not limited to those precise embodiments, and the embodiments as below, for example, can be within the scope of the present invention. Furthermore, the present invention can be implemented with various modifications other than the followings without departing from the scope of the invention.

(1) In the above embodiment, the door trim 14 is divided into two members (the upper board 14a and the lower board 14b ), however, the present invention is applicable even when the door trim 14 is divided into three or more members.

(2) In the above embodiment, the clip 30 is formed separately from the positioning pin 26 and the positioning bracket 28, however, the present invention is applicable even when the clip 30 is formed integrally with the positioning pin 26 or the positioning bracket 28.

(3) In the above embodiment, the door for the vehicle 10 is a side door for the front seats (a door in the driver's seat side or in the passenger's seat side), however, the present invention is applicable even when the door for the vehicle 10 is a side door for the rear seats.

1. A door for the vehicle comprising:
a door inner panel;
a door trim mounted to the inner side of a compartment of the door inner panel;
a door cover mounted on a peripheral edge in the rear side of a compartment of the door inner panel; and
a coupling means for mutually coupling the door trim and the door cover.

2. The door for the vehicle according to claim 1, wherein a positioning pin is provided in the door trim, a positioning bracket is provided in the door cover, and an insertion hole into which the positioning pin is inserted is formed in the bracket.

3. The door for the vehicle according to claim 2, comprising a clip for preventing the positioning pin from slipping off the insertion hole in such a state that the positioning pin is inserted in the insertion hole, wherein the clip is constituted separately from the positioning pin and the positioning bracket, and the coupling means is composed of the positioning pin, the positioning bracket and the clip.

4. The door for the vehicle according to claim 1, wherein the door trim is vertically divided, and the dividing position in the vertical direction of the door trim coincides with the upper end position of the door cover.

5. The door for the vehicle according to claim 2, wherein the door trim is vertically divided, and the dividing position in the vertical direction of the door trim coincides with the upper end position of the door cover.

6. The door for the vehicle according to claim 3, wherein the door trim is vertically divided, and the dividing position in the vertical direction of the door trim coincides with the upper end position of the door cover.
